(19) United States
(12) Patent Application Publication
(10) Pub. No.: US 2003/0130863 A1
(43) Pub. Date: Jul. 10, 2003

(54) Method and apparatus for associating a non-binding attribute with an order

(76) Inventors: William Grey, Millwood, NY (US); Clifford A. Pickover, Yorktown Heights, NY (US); Paul A. Moskowitz, Yorktown Heights, NY (US); Peter G. Capek, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 10/042,802

(22) Filed: Jan. 9, 2002

(51) Int. Cl. G06F 17/60

(52) U.S. Cl. 705/1

(57) ABSTRACT

A system, method, apparatus, means, and computer program code for creating and using an order for a product (e.g., a good and/or a service) that has a non-binding attribute such that different configurations of the product are possible that will satisfy the order. A non-binding attribute may allow more than one component to be used to build a product, each of which provides a level of functionality or capability acceptable to the customer. Thus, different components may result in different product configurations. A company manufacturing the product in accordance with the order may wait until building the product to determine which configuration to use.

### FIELD OF THE INVENTION

The present invention relates to a method and apparatus for creating an order for a good or service that has a non-binding attribute and, more particularly, embodiments of the present invention relate to methods, means, apparatus, and computer program code for allowing an order to be fulfilled according to one or more configurations associated with the order.

### BACKGROUND OF THE INVENTION

Build-to-order, configure-to-order, and other just-in-time manufacturing techniques and production methods are widely used for producing customized goods and/or services. In a company using such techniques and methods, the company may maintain little, if any, inventories of finished goods. Rather, the company may wait for a customer order before completing or building the goods needed to fulfill the order. Such a methodology may reduce the risk to the company of holding or storing finished goods, which may lose value over time. For example, computers held in a company's inventory may lose value to customers very quickly due to the rapid rate of obsolescence of such products. In addition, maintaining an inventory of finished goods may cost more than maintaining inventories of components used to produce the goods.

While build-to-order and just-in-time manufacturing methods can be effective at reducing the inventory of finished goods, such methods typically require careful management of component inventories used to make different products and/or careful coordination between manufacturers and their suppliers. If a supply disruption or shortage occurs regarding a component used for a finished good that a company is attempting to manufacture quickly, the company may not be able to fulfill the order in a timely or required manner. Thus, the company's build-to-order process may cause it to lose an order or be unable to fulfill the order.

It would be advantageous to provide a method and apparatus that overcame the drawbacks of the prior art. In particular, it would be desirable to provide a method and apparatus that allowed a company greater flexibility in fulfilling orders while enabling the company to produce finished goods using build-to-order methods. In addition, it would be desirable to provide a method and apparatus that enabled a company to modify production or order fulfillment plan for a first order to accommodate a new or special order while satisfying customers in both of the orders.

### SUMMARY OF THE INVENTION

Embodiments of the present invention provide a system, method, apparatus, means, and computer program code for creating and using an order for a product (e.g., a good and/or a service) that has a non-binding attribute such that different configurations of the product are possible that will satisfy the order. A company manufacturing the product in accordance with the order may wait until building the product to determine which configuration to use. A customer placing the order may receive a lower price for the order in exchange for being flexible on how the order is fulfilled. Alternatively, the customer may receive a better product as a result in a change in configuration. The non-binding attribute may be agreed to by the customer and the company as part of the order such that the non-binding attribute is part of the sale consummated between the customer and the company for the order. A non-binding attribute may allow more than one component to be used to build a product, each of which provides a minimum level of functionality or capability acceptable to the customer. For example, a customer purchasing computers may want the computers to each have a hard disk drive having a minimum of twenty gigabytes of storage space. Thus, the customer may be willing to accept computers with disk drives of thirty gigabytes of storage space.

Additional objects, advantages, and novel features of the invention shall be set forth in part in the description that follows, and in part will become apparent to those skilled in the art upon examination of the following or may be learned by the practice of the invention.

According to embodiments of the present invention, a method for developing an order for a product may include establishing an order for a product, wherein the order includes a first component associated with the product and the order includes a non-binding attribute associated with the first component; determining a second component that satisfies the non-binding attribute for the order; and exchanging the first component with the second component in the order. In another embodiment, a method for fulfilling an order for a product may include establishing an order, wherein the order identifies an initial configuration for a product and at least one non-binding attribute associated with the initial configuration; after the order is established, determining an alternate configuration for the product in accordance with the at least one non-binding attribute; and fulfilling the order in accordance with the alternate configuration. In a further embodiment, a method for completing an order for a product may include establishing an order involving a first component, wherein the order includes a non-binding attribute associated with the first component; determining a shortage of an amount of the first component needed to fulfill the order; determining a second component that satisfies the non-binding attribute for the order; and exchanging the first component with the second component for the order.

According to embodiments of the present invention, a system for facilitating an order for at least one product may include a memory; a communication port; and a processor connected to the memory and the communication port, the processor being operative to establish an order for a product, wherein the order includes a first component associated with the product and the order includes a non-binding attribute associated with the first component; determine a second component that satisfies the non-binding attribute for the order; and allow exchange of the first component with the second component in the order. In another embodiment, the processor instead may be operative to establish an order, wherein the order identifies an initial configuration for a product and at least one non-binding attribute associated with the initial configuration; after the order is established, determine an alternate configuration for the product in accordance with the at least one non-binding attribute; and process fulfillment of the order in accordance with the alternate configuration. In a further embodiment, the processor instead may be operative to establish an order involving a first component, wherein the order includes a non-binding attribute associated with the first component; determine a shortage of an amount of the first component needed to fulfill the order; determine a second component that satisfies the non-binding attribute for the order; and allow exchange of the first component with the second component for the order.

According to embodiments of the present invention, a computer program product in a computer readable medium for facilitating an order for at least one product may include first instructions for creating an order for a product, wherein the order includes a first component associated with the product and the order includes a non-binding attribute associated with the first component; second instructions for identifying a second component that satisfies the non-binding attribute for the order; and third instructions for allowing use of the first component with the second component in the order. In another embodiment, a computer program product in a computer readable medium for fulfilling an order for a product may include first instructions for creating an order, wherein the order identifies an initial configuration for a product and at least one non-binding attribute associated with the initial configuration; second instructions for identifying an alternate configuration for the product in accordance with the at least one non-binding attribute; and third instructions for allowing fulfillment of the order in accordance with the alternate configuration. In a further embodiment, a computer program product in a computer readable medium for completing an order for a product may include first instructions for creating an order involving a first component, wherein the order includes a non-binding attribute associated with the first component; second instructions for identifying a shortage of an amount of the first component needed to fulfill the order; third instructions for identifying a second component that satisfies the non-binding attribute for the order; and fourth instructions for allowing exchange of the first component with the second component for the order.

According to embodiments of the present invention, an apparatus for facilitating an order for at least one product may include means for creating an order for a product, wherein the order includes a first component associated with the product and the order includes a non-binding attribute associated with the first component; means for identifying a second component that satisfies the non-binding attribute for the order; and means for allowing use of the first component with the second component in the order. In another embodiment, an apparatus for fulfilling an order for a product may include means for creating an order, wherein the order identifies an initial configuration for a product and at least one non-binding attribute associated with the initial configuration; means for identifying an alternate configuration for the product in accordance with the at least one non-binding attribute; and means for allowing fulfillment of the order in accordance with the alternate configuration. In a further embodiment, an apparatus for completing an order for a product may include means for creating an order involving a first component, wherein the order includes a non-binding attribute associated with the first component; means for identifying a shortage of an amount of the first component needed to fulfill the order; means for identifying a second component that satisfies the non-binding attribute for the order; and means for allowing exchange of the first component with the second component for the order.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of components for an embodiment of a server of FIG. 4;

FIG. 6 is an illustration of a representative customer information database of FIG. 5;

FIG. 7 is an illustration of a representative order information database of FIG. 5;

FIG. 8 is an illustration of a representative component information database of FIG. 5; and

FIG. 9 is an illustration of a representative supplier information database of FIG. 5.

### DETAILED DESCRIPTION

Applicants have recognized that there is a need for systems, means and methods that a configuration of a product to be changed after an order for the product is created. The order may allow or specify different configurations or one or more components to be used in place or one or more other components for the product. Changes in configuration may be made to respond to unexpected changes in demand for the product or one or more components of the product or inventory levels of the product, volume discount agreements, price changes for products or their components, special or emergency orders for products, etc. The order may specify when a component can be exchanged for another component in the order, what components can be switched for an order, what different configurations are allowable for a product in an order, etc. These and other features will be discussed in further detail below, by describing a system, individual devices, and processes according to embodiments of the invention.

For purposes of the present invention, a “product” may be or include one or more goods and/or one or more services. A product may be a physical object (e.g., chair, computer, razor, chemical, clock, food product, car) or an electronic or digital object (e.g., software, e-book, digitized movie), or a service (e.g., travel, legal, consulting). A product may comprise a single component or multiple components and a product may itself be a component in another product. The methods, apparatus, means, etc. disclosed herein may be used in many different industries such as, for example, the manufacture of automobiles, pharmaceuticals, computers or electronic equipment, clothing, etc., food catering and restaurants, construction, etc.

As one example of how the present invention may be used, suppose that a small company enters into an agreement or establishes an order with a manufacturer to purchase ten computers from the manufacturer. Each computer will have 128 megabytes of RAM, a Pentium IV™ microprocessor, and a thirty-gigabyte hard disk drive. At the time of the order, the manufacturer has an adequate supply of all of these components, so it commits to the order. After booking this order, the manufacturer receives a request from a large company to supply ten thousand computers, all of which must be supplied with identical thirty-gigabyte hard disk drives to simplify maintenance and support. The manufacturer has exactly ten thousand of the thirty-gigabyte disk drives in stock, so in theory it could fulfill the order from the large company. However, it would then be unable to fulfill the order from the small company. Since the manufacturer has already committed to the order from the small company, it may do so while jeopardizing its ability to accept the order from the large company. Now assume that in the order with the small company the manufacturer provided a provision that enabled the manufacturer to exchange forty-gigabyte hard disk drives for the thirty-gigabyte hard disk drives at no additional cost to the small company. Given the profit made by the manufacturer in accepting the order from the large company, the manufacture may be willing to do so in order to satisfy both orders. The large company gets exactly what it requested and the small company gets computers that are better (e.g., have more storage capacity) than what the small company originally wanted, for the same price. The present invention enables flexibility in the first order to allow the manufacturer to fulfill both orders.

Process Description

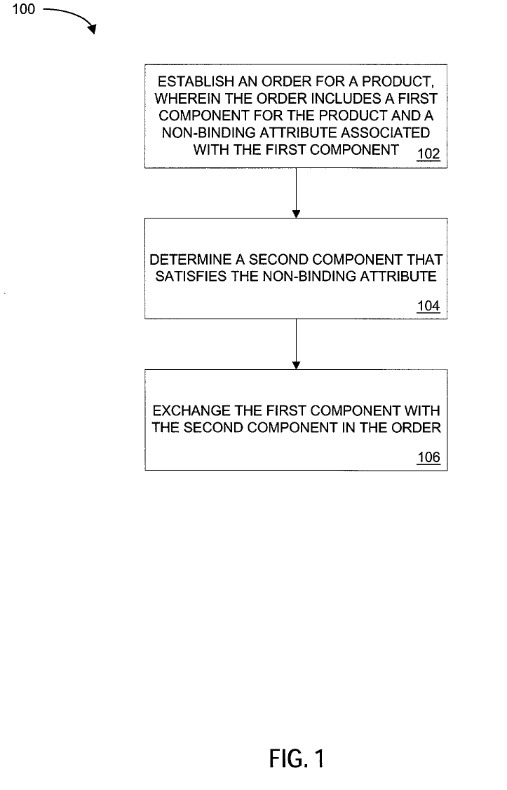

Reference is now made to FIG. 1, where a flow chart 100 is shown which represents the operation of an embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

Processing begins at a step 102 during which an order is established for a product. The order may include or specify a component with the product and a non-binding attribute associated with the component and, as a result, the product and the order. In some embodiments, the order may be or be part of a legal agreement or formal contract between two or more parties (e.g., a supplier, manufacture, customer, etc. of a product). In some embodiments, information regarding one or more orders and/or one or more components may be stored in, or retrieved from, an order and/or component information database.

Preferably, the order established during the step 102 identifies or otherwise includes a component for a product and a non-binding attribute associated with the component. For example, a computer product may include many different components including, but not limited to, motherboards, keyboards, monitors, disk drives, speakers, etc. A non-binding attribute associated with a component may allow the component to be exchanged for a different component. For example, an order for a computer product may allow a fifteen inch monitor to be replaced by a larger size monitor, a keyboard to be replaced by a more extensive keyboard, etc.

As another example, an order for a desk may allow the desk to come in different colors, with different drawer handles, a larger size, etc. The component for the product (e.g., the desk) may be the handles and the non-binding attribute may be the color and/or size of the handles. The order may specify which of a variety of handles can be exchanged for the original handles for the desk and allow any of the specified handles to be used to fulfill the order.

An order may be established in many ways. For example, a manufacturer or supplier of a product may operate a Web site (e.g., www.amazon.com, www.ladders.com) at which consumers may order a product, select components for the product, specify one or more non-binding attributes for the product or order, specify a quantity desired of the product, indicated a preferred delivery method, provide a credit card number, etc. Alternatively, two entities may negotiate an order over a period of time in person, via electronic means (e.g., email messages, teleconferencing, e-negotiating). As another example, a company may receive an order via mail, email, or telephone call center. In some embodiments, information regarding one or more users, consumers, customers, etc. may be stored in, or retrieved from, a customer information database.

In another example, a Web site may allow a customer to select a product as part of an order. The Web site may then provide options to the customer regarding one or more non-binding attributes that may be used with the product or associated with the order. For example, a customer purchasing one or more bicycles via a Web site may identify the basic model desired by the customer and the quantity of bicycles that the customer wants with the order. The Web site may determine a current or expected inventory for components of the bicycle and provide options to the customer regarding seats, tires, derailers, etc. that the customer can select. The customer may allow each of the bicycles in the order to be built with any one of three different seats and any one or two different tires while requiring a specific derailer, so long as all of the bicycles are identical. Thus, the order has two non-binding attributes, one for seats and one for tires, thereby providing the supplier of the bicycles some flexibility in satisfying the order as six different possible configurations are possible in the order. The order may specify that the customer will pay the same price for each of the six different bicycle configurations or that the customer will pay different prices for two or more of the six possible configurations.

As yet another example, a person may place an order for a bicycle and specify minimum requirements for the bicycle. The order may identify specific components for the tires, seat and derailer. The person may be willing to let substitute components be used for the tires and seat without identifying the allowable substitute components. That is, the person may let alternative tires and seat be used with the bicycle so long as they satisfy the minimum requirements, such as meeting a designated safety requirement, or having a manufacturer's suggested retail price above a certain threshold. Therefore, non-binding attributes have been established for the order with regard to the tires and seat.

A non-binding attribute may be or include many things. For example, a nonbinding attribute associated with the order established during the step 102 may be or include one or more of the following: a quality level, performance level, feature set, storage capacity, size, color, weight, bandwidth, technical capability, dimension, delivery date, expiration date, price, service level, purity level, warranty level, etc. of a component for a product associated with the order.

In some embodiments, the step 102 or the method 100 may include determining the non-binding attribute. For example, a manufacturer may receive an order or request for an order from a customer for a product and determine the manufacturer's current or future ability to fulfill the order. The manufacturer may want to include some flexibility in how it fulfills the order. Thus, the manufacturer may suggest various non-binding attributes to associate with the order to the customer based on the manufacturer's current or expected amount of components for the product in inventory, any characteristics for the product specified by the customer, etc. The manufacturer and the customer then may establish an order based on the manufacturer's suggestions, the customer's requirements, and the customer's ability or willingness to accept one or more non-binding attributes with the order.

In some embodiments, the step 102 of establishing an order for a product may be or include one or more of the following: providing a notification to a customer regarding a non-binding attribute associated with the order; receiving an order for the product; allowing a customer to select a plurality of components for the product; allowing a customer to select the product and a non-binding attribute associated with the product; providing a notification to a customer regarding a non-binding attribute associated with a product and one or more components that may satisfy the non-binding attribute; providing at least two options regarding at least one component for the product and allowing a customer to select from among the two options; providing a request to a customer regarding a non-binding attribute associated with a first component (e.g., requesting that the customer agree to the non-binding attribute as part of the order); etc.

In some embodiments, the order established during the step 102 may identify a characteristic associated with the product. The characteristic may indicate a desired or required feature for a product, a condition that must be satisfied with an order, an unacceptable configuration of a product, etc. For example, a characteristic may require that a product not weigh more than some upper limit, that a product not use components having certain colors, that a product use only certain designated colors, that a product have certain dimensions, that a product not exceed one or more designated dimensions, etc. The method 100 may include identifying the characteristic (e.g., receiving a notification regarding the characteristic, or questioning a customer regarding the characteristic).

An order may specify many things in regard to a characteristic such as, for example: an acceptable lower and/or upper bound of the at least one characteristic; a range of acceptable and/or unacceptable characteristics; a rule regarding exchange of a component with another component; a condition that must be met if a first component is exchanged with a second component for the order; a set of at least one acceptable and/or unacceptable characteristic for a product or a component; a rule regarding what product to use for an order; etc. The method 100 may include determining a characteristic for an order, which may further include receiving a notification regarding the characteristic.

The non-binding attribute associated with the order established during the step 102 may be based, at least in part, on the characteristic. For example, a customer may allow different configurations in an order for computers, so long as all of the computers provided under the order are identical and are predominantly white in color. A supplier may want to identify at least one non-binding attribute that can be associated with the order. The supplier may have monitors of different sizes, only one of which is in white. Therefore, the non-binding attribute cannot relate to monitors since only one monitor is available that meets the characteristic. However, the supplier may have several different kinds of speakers that may be used with the computers, all of which are white. Thus, the supplier may propose that the order have a non-binding attribute in regards to which of the white speakers are provided with the computers.

In some embodiments, a characteristic may be determined or identified by various parties or devices. For example, a characteristic may be determined or identified by a party placing an order; a supplier of a product or a component associated with an order; an expert system; a rule-based system; an algorithm, an order model; a forecasting system; supply chain management decision support system, a customer model; a supplier relationship management decision support system; a production control decision support system; an optimization model or system; etc.

In some embodiments, a characteristic may be based on a product or component. For example, a characteristic may be based on a volume (e.g., a customer may want to use lighter weight components to keep total weight for all products in an order below a designated amount), inventory level or availability (e.g., a customer may want to use components currently in stock so that the customer does not have to wait for fulfillment of its order); quantity, quality (e.g., a customer may set a minimum quality threshold for a component or product), etc. of a product or component associated with an order; current, expected or projected demand for a product or component (e.g., a purchaser may want to use only components currently used by other purchasers); supply of a component or product or a component; an expected or projected profit margin for a product when the product includes a specific component (e.g., a manufacturer may want to use only components that assure a certain expected profit margin); a discount available for a product or a component (e.g., a customer may prefer to use components that a provide the customer the best cost price for an order); a price of a product or component (e.g., a customer may want to use components costing less than some designated amount); etc.

During a step 104 a component is identified or otherwise determined that satisfies a non-binding attribute associated with the order established during the step 102. For example, if an order specifies that a computer is to be provided with a thirty gigabyte hard disk drive but that a larger disk is acceptable, the step 104 may include identifying a larger capacity disk drive.

The component determined during the step 104 may be determined in accordance with a characteristic associated with the order established during the step 102. For example, a non-binding attribute associated with an order may allow different clock faces to be used to fulfill an order for clocks. The characteristic may require that the clocks use only roman numerals on the clock faces. When determining which clock-face to use to fulfill the order, all clock-faces using Arabic numerals can be disregarded since they do not satisfy the characteristic associated with the non-binding attribute.

If the order established during the step 102 specifies one or more specific components that may satisfy the non-binding attribute, all or part of the step 104 may be completed as part of the step 102. Alternatively, the step 104 may include selecting or identifying one or more of the allowable components, which may be done as a result of a check of current or expected inventory to determine what components are or will be available to fulfill the order. In some embodiments, an expert system, model, heuristic, rule-based system, procedure, process, algorithm, etc. may be used to identify one or more components.

In some embodiments, the step 104 of determining a component that satisfies a non-binding attribute may be or include one or more of the following: identifying a component that can replace another component in a product and satisfy the non-binding attribute; receiving a notification of a selection of the component from a customer or other party; providing a notification of availability of a component that satisfies the non-binding attribute (and perhaps allowing a customer or other party to consent to use of the component); receiving a request to exchange a first component in a product with a second component, both of which satisfy the non-binding attribute; receiving consent or a request to exchange one component with a different component; providing a notification to a customer of at least one component that satisfies the non-binding attribute; confirming availability of a component that satisfies the non-binding attribute; confirming ability of a second component to satisfy the non-binding attribute; selecting a second component from a plurality of components identified in an order as replacements for a first component; etc.

During a step 106, a component previously associated with the order established during the step 102 is replaced or exchanged with the component determined during the step 104. Presumably both components satisfy the non-binding attribute associated with the order established during the step 102. The order may be fulfilled, provided, delivered, etc. using the new component as opposed to the originally identified component.

In some embodiments, the step 106 of exchanging a first component with a second component in an order or in building a product may be or include using the second component instead of the first component in building or providing the product, including the second component in the product, fulfilling the order with the second component but not the first component, etc.

In some embodiments, the step 106 or the method 100 may include providing a notification to a customer or other party associated with the order of a change in components. A party implementing the method may ship or fulfill the order with the component determined during the step 104.

As previously discussed above, in some embodiments, the use of different components or different product configurations with an order may change the price of the order. The order established during the step 102 may reflect such different prices for different components and/or configurations. The method 100 my include adjusting a price associated with an order as a result of a change in components with the order, providing a notification to a customer or other party regarding the price or price adjustment, etc. Of course, in some instances there may not be a price change with an order.

In some embodiments, a component that is exchanged with the component determined during the step 104 may be used with a different product, different order, etc. and a new order may be established that uses the component. The new order may be established with the same or a different customer than that customer that placed the order established during the step 102.

In some embodiments, the method 100 may include determining a need for a component associated with the order established during the step 102 outside of the order. For example, in some situations, a receipt of the new order may cause an inability to fulfill the first order if the second order is fulfilled. As another example, an unexpected shortage of the component (e.g., when a supplier is unable to deliver expected components, or when a manufacturer discovers defects in components held in inventory) may limit an ability to fulfill the order established during the step 102 with the component. The method may include fulfilling one or more of the orders.

In some embodiments, determining a need for a component outside the order established during the step 102 may be or include one or more of the following: receiving a notification regarding a new order that requires the component; determining that the order cannot be partially or completely fulfilled due to a shortage of the component; determining that the order cannot be partially or completely fulfilled due to defects of the component; determining that a change in price for a component makes it less profitable to fulfill the order; determining that a change in price for a substitute product makes it more profitable to use that substitute product; receiving a new order that requires an amount of the component such that both the original order and the new order cannot be filled if both orders use the component; establishing a new order that requires the component; receiving an indication of a potential new order that requires the component; determining that an order cannot be partially or completely filled due to defects detected in a component; determining that a change in price for a component makes it disadvantageous to fill an order with the component; determining that a change in price for a second component makes it disadvantageous to fill an order with a first component; determining that a change in projected supply for a component makes it disadvantageous to fill an order with the component; determining that a change in projected supply for a second component makes it disadvantageous to fill an order with a first component; determining that a projected change in price for a component makes it disadvantageous to fill an order with the component; determining that a projected change in price for a second component makes it disadvantageous to fill an order with a first component; etc.

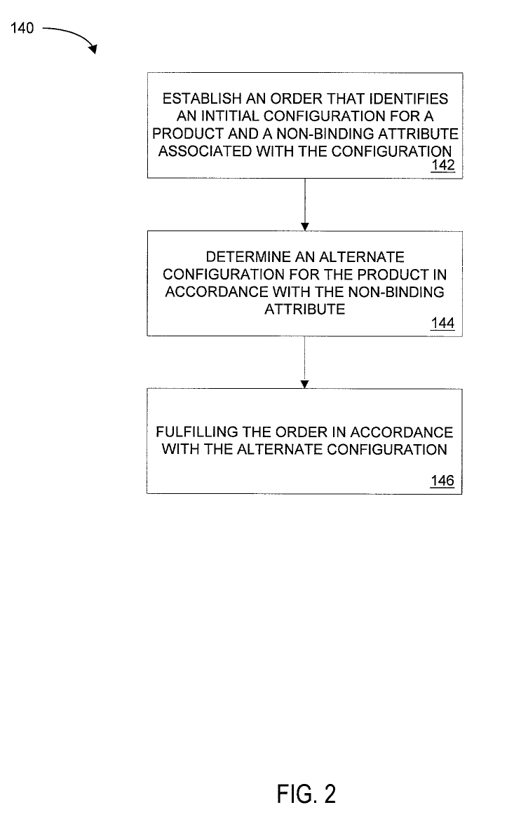

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. In some embodiments, the method 140 may include some or all of the variations previously discussed above in relation to the method 100.

Processing begins at a step 142 during which an order is established that identifies an initial configuration for a product and at least one non-binding attribute associated with the initial configuration. The step 142 is similar to the step 102 previously discussed above. In some embodiments, the order may be or be part of a legal agreement or contract. The order may establish different prices for different configurations of the product or order, different applications of the non-binding attribute, etc. The order also may include or describe a characteristic associated with the order, one or more products in the order, etc.

An initial configuration may designate or identify one or more components that comprise a product or are otherwise included in the product. The non-binding attribute may allow one or more of the components to be altered or exchanged or the product to be built, provided, etc. in a manner different from the original configuration. For example, a non-binding attribute may allow a product's color or texture to be different than in the initial configuration and/or allow one component to be exchanged for another component in the configuration. In some embodiments, a configuration change of the product may not require an exchange of one component for another, but may instead require a change in a component or other characteristic of the product (e.g., color, installed software, operating capability). For example, one configuration of a product may allow the product to transmit or receive data at a higher rate than another configuration, even though no components for the product have been switched. In some embodiments, a product ordered by a customer or initially selected for order may form a default or initial configuration for the product.

In some embodiments, the step 142 or determining a product configuration may be or include one or more of the following: providing a notification to a customer regarding a non-binding attribute associated with the product configuration; receiving an order for the product configuration from a customer; receiving a request from a customer for the product in an initial configuration; allowing a customer to select a plurality of components for a product; allowing a customer to select a product and a non-binding attribute associated with the product; allowing a customer to select a product and an initial configuration for the product; providing a notification to a customer regarding an initial configuration and receiving consent from a customer to use the initial configuration; providing a notification to a customer regarding an initial configuration and an associated non-binding attribute and receiving consent from the customer to use the initial configuration and the non-binding attribute with an order; providing at least two options regarding an initial configuration for a product and allowing a customer to select from among the at least two options; providing at least two options regarding at least one component for a product and allowing a customer to select from among the at least two options; providing at least two options regarding at least one non-binding attribute for a product and allowing a customer to select from among the at least two options; providing a request to a customer regarding a non-binding attribute for an initial configuration; etc.

In some embodiments, the step 142 may include determining a non-binding attribute as previously discussed above in relation to the step 102.

During a step 144, an alternate configuration is determined for the product in accordance with the non-binding attribute associated with the product for the order established during the step 142. The step 144 is similar to the step 104 previously discussed above. In some embodiments, alternate configurations and their price adjustments, if any, may be specified explicitly in the order established during the step 142.

In some embodiments, the step 144 of determining an alternative configuration may be or include one or more of the following: selecting an alternate configuration from among potential configurations for the product that satisfy the non-binding attribute; determining a component that can replace another component in the product and satisfy the non-binding attribute; receiving a notification of a selection of an alternative component for the product; receiving consent to exchange the initial configuration with an alternate configuration; providing a notification of availability of an alternate configuration; determining availability of a component needed for an alternate configuration; receiving a request to exchange an initial configuration with an alternate configuration; providing a notification to a customer of at least one component that satisfies the non-binding attribute and is usable in an alternate configuration; providing a notification to a customer of at least one component that is unavailable for use in the initial configuration; providing a notification to a customer of at least one component that is available for use in the alternate configuration; confirming ability of a component to satisfy the non-binding attribute; selecting an alternate configuration from configurations permitted by or in the order; etc.

In some embodiments, changing configurations for a product or order may result in an adjustment of a price of the product or order. The order established during the step 142 may describe or define when and how a price adjustment is going to be made. The method 140 may include adjusting a price as a result of a configuration change in an order or product, providing a notification to a customer or other party regarding the price change, providing a rebate or credit if the order had already been paid for prior to the change in configuration, etc.

During a step 146, the order established during the step 142 is fulfilled in accordance with the alternate product configuration determined during the step 144. Fulfilling an order may be or include building, assembling, manufacturing, configuring, customizing, duplicating, preparing, shipping, or delivering a product. Alternatively, fulfilling an order may be or include providing information regarding the order to another party or device that can build, assemble, manufacture, configure, customize, duplicate, prepare, ship, deliver, etc. the product or authorizing or directing another party to build, assemble, manufacture, configure, customize, duplicate, prepare, ship, deliver, etc. the product. In some embodiments, the step 146 of fulfilling an order in accordance with a product configuration may be or include one or more of the following: providing a notification that an order or product is provided in accordance with an alternate configuration; building or providing an order or product in accordance with an alternate configuration; using a component with an order or product that is included in an alternate configuration but not in an initial configuration established with the order established during the step 142; etc.

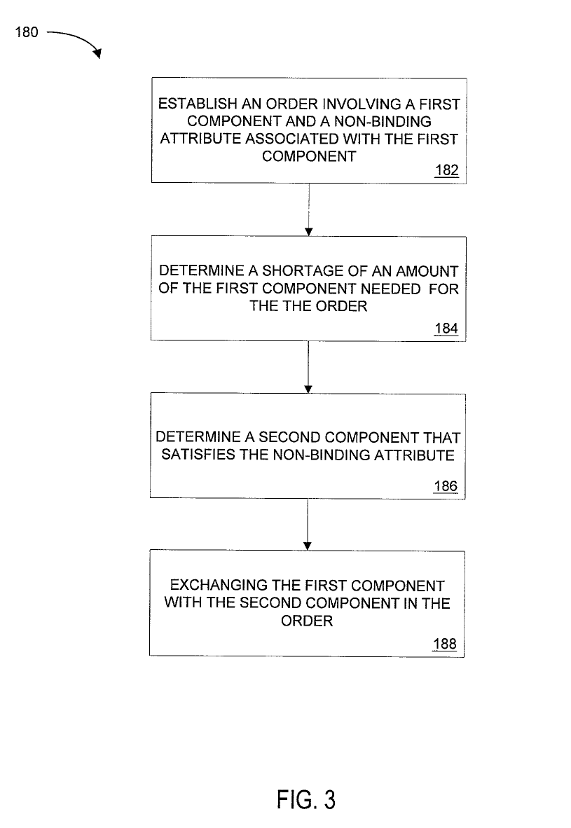

Reference is now made to FIG. 3, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. In some embodiments, the method 180 may include some or all of the variations previously discussed above in relation to the method 100 or the method 140.

Processing begins at a step 182 during which an order is established that involves a first component and a non-binding attribute associated with the first component. The step 182 is similar to the steps 102 and 142 previously discussed above. The order established during the step 182 may be or be part of a legal contract or agreement. The step 182 or the method 180 may include determining the non-binding attribute, establishing one or more prices associated with the order, or other of the variations and features previously discussed above in relation to the methods 100 and 140.

In some embodiments, the step 182 or establishing an order involving a component and a non-binding attribute may be or include one or more of the following: providing a notification to a customer regarding the order, component or non-binding attribute; receiving an order for a product that specifies the component and the non-binding attribute; allowing a customer to select a plurality of components for a product; allowing a customer to select the non-binding attribute; providing a notification to a customer regarding a component and receiving consent from the customer to use the component in the order; providing a notification to a customer regarding a non-binding attribute and receiving consent from the customer to use the non-binding attribute in the order; providing at least two options regarding a component and allowing a customer to select from among the two options; providing a request to a customer regarding a non-binding attribute associated with a component; etc.

During a step 184, a current, future or expected shortage of the component associated with the order established during the step 182 is determined. The shortage may result from disruptions in supply of the component, increased demand for the component, inability to procure the component at an acceptable price, low inventory levels of the component, use of the component in other products or orders, etc. The shortage may be temporary or permanent and may vary depending on geographic location, time of year, type of component, size or orders, etc. For example, a manufacturer may face a temporary shortage for a component in inventory when orders received require amounts of the component that exceed the manufacturer's current inventory levels. As another example, a manufacturer may face a long term shortage for a component if a supplier of the component goes out of business or reduces the number of the components the supplier provides to the manufacturer or has available to provide to the manufacturer.

In some embodiments, the step 184 or determining a shortage of a component needed for an order may be or include one or more of the following: receiving a second order involving the component, fulfillment of which prevents fulfillment of the previous order with the component; determining availability of an amount of the component needed to fulfill the order; determining that an amount of the component needed for the original order exceeds an amount of the component that is available; determining that an amount of the component needed for the order exceeds an amount of the component in inventory; determining that the order cannot be partially or completely fulfilled due to defects of the component; determining that a change in price for a component makes it less profitable to fulfill the order; determining that a change in price for a substitute product makes it more profitable to use that substitute product; determining that the order cannot be partially or completely filled due to one or more defects detected in a product or component; determining that a change in price for a component makes it disadvantageous to fill the order with the component; determining that a change in projected supply for a component makes it disadvantageous to fill the order with the component; determining that a change in projected supply for a second component makes it disadvantageous to fill the order with a first component; determining that a change in price for a second component makes it disadvantageous to fill the order with a first component; etc.

During a step 186, a replacement component is determined that satisfies the non-binding attribute and may replace the component originally associated with the order. The step 186 is similar to the step 104 previously discussed above.

During a step 188, the component identified during the step 186 is used with the order instead of the component identified during the step 182. The step 188 is similar to the step 106 previously discussed above.

As with the methods 100, 140 previously discussed above, changing the order established during the step 182 may result in a price adjustment for the order. An order may designate one or more price adjustments and how or when such price adjustments will be applied, what parties will be notified when a price adjustment is made, etc.

System

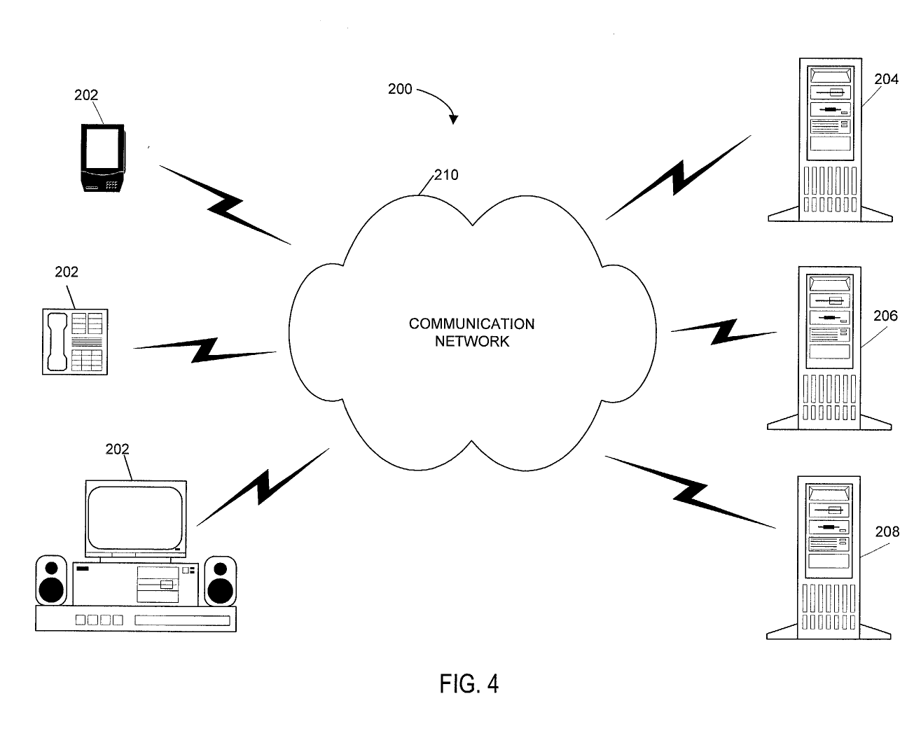

Now referring to FIG. 4, an apparatus or system 200 usable with the methods disclosed herein is illustrated. The apparatus 200 includes one or more user or client devices 202 that may communicate directly or indirectly with one or more servers, controllers or other devices 204, 206, 208 via a computer, data, or communications network 210. For purposes of further explanation and elaboration of the methods disclosed herein, the methods disclosed herein will be assumed to be operating on, or under the control of, the server 204. A server may be implemented by a manufacturer, supplier, distributor, etc. of a product and/or may be operated by an entity on behalf of one or more manufacturers, suppliers, distributors, etc.

A server 204 may implement or host a Web site, database, telephone call center or other facility to allow users to place or provide orders. A user may use a user device 202 to access the Web site, database, call center, etc. A server 204 can comprise a single device or computer, a networked set or group of devices or computers, a workstation, etc. In some embodiments, a server 204 also may function as a database server and/or as a user device. In some embodiments, a customer may use a user device 202 to establish or provide an order. Alternatively, or in conjunction, a customer may place or provide an order via one of the servers 206, 208. For example, a manufacturer and a distributor may use servers to exchange order information, negotiate orders, etc. The use, configuration and operation of servers will be discussed in more detail below.

The user or client devices 202 preferably allow entities to interact with the servers 204, 206, 208 and the remainder of the apparatus 200. The user devices 202 also may enable a user to access Web sites, software, databases, etc. hosted or operated by the servers 204, 206, 208. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, television, information appliance, wearable computing device, telematics device, smart phone, etc. In some embodiments, information regarding one or more users and/or one or more user devices may be stored in, or accessed from, a user information database and/or a user device information database.

Many different types of implementations or hardware configurations can be used in the system 200 and with the methods disclosed herein, and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 4 is meant only to be generally representative of cable, computer, telephone, peer-to-peer or other communication networks for purposes of elaboration and explanation of the present invention, and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone =networks, radio links, fiber optic transmission lines, ISDN lines, T1 lines, DSL, etc. In some embodiments, a user device may be connected directly to a server without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 4 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204, 206, 208.

Although three user devices 202 and three servers 204, 206, 208 are shown in FIG. 4, any number of such devices may be included in the system 200. The devices shown in FIG. 4 need not be in constant communication. For example, a user device may communicate with a server only when such communication is appropriate or necessary.

Server

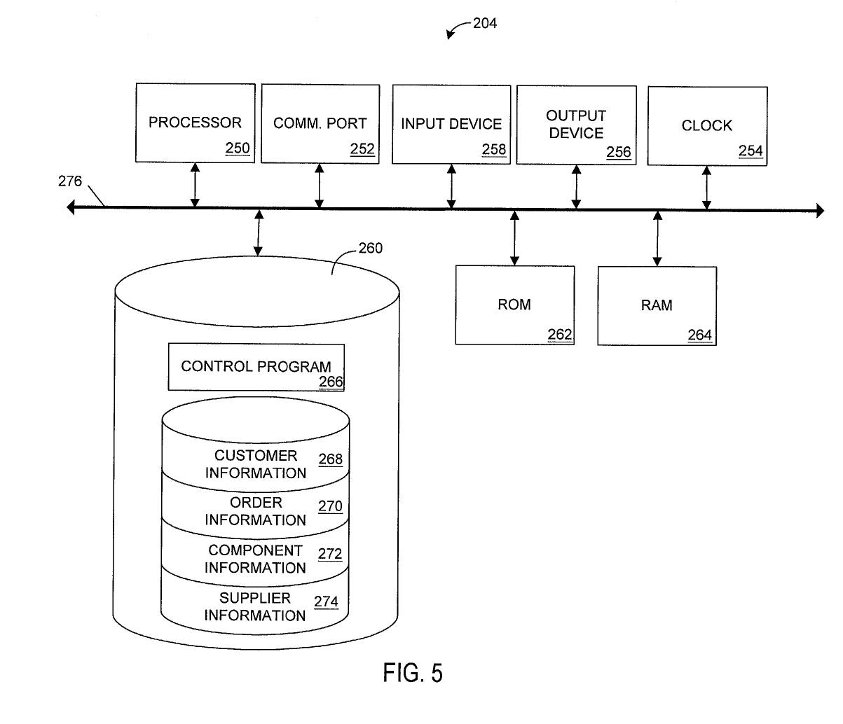

Now referring to FIG. 5, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, orders, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, user devices, orders, products, components, attributes, characteristics, prices, communications, etc. For example, information regarding one or more customers may be stored in a customer information database 268 for use by the server 204 or another device or entity. Information regarding one or more orders may be stored in an order information database 270 for use by the server 204 or another device or entity and information regarding components may be stored in a component information database 272 for use by the server 204 or another device or entity. Information regarding one or more suppliers may be stored in a supplier information database. In some embodiments, some or all of one or more of the databases may be stored or mirrored remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 276.

While specific implementations and hardware configurations for servers 204 have been illustrated, it should be noted that other implementations and hardware configurations are possible and that no specific implementation or hardware configuration is needed. Thus, not all of the components illustrated in FIG. 4 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be used to provide or negotiate orders, receive information regarding orders, etc. In some embodiments, a user device may be or include any of a number of different types of devices, including, but not limited to a personal computer, portable computer, mobile or fixed user station, workstation, network terminal or server, telephone, cellular telephone, smart phone, beeper, kiosk, dumb terminal, personal digital assistant, facsimile machine, two-way pager, radio, cable set-top box, television, telematics device, information appliance, wearable computing device, etc. In some embodiments, a user device 202 may have the same structure or configuration as the server 204 illustrated in FIG. 5 and include some or all of the components of the server 204.

Databases

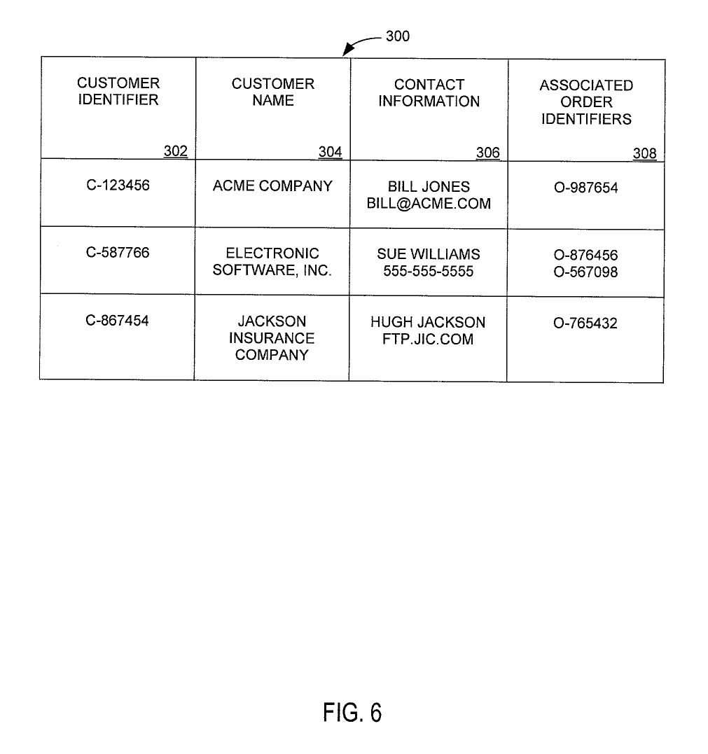

As previously discussed above, in some embodiments a server, user device, or other device may include or access a customer information database for storing or keeping information regarding one or more customers. One representative customer information database 300 is illustrated in FIG. 6.

The customer information database 300 may include a customer identifier field 302 that may include codes or other identifiers for one or more customers, a customer name field 304 that may include names, descriptions, contact information, etc. for the customers identified in the field 302, a contact information field 306 that may include contact information for the customers identified in the field 302, and an associated order identifiers field 308 that may include codes or other identifiers for one or more orders associated with the customers identified in the field 302. Other or different fields also may be used in the customer information database 300. For example, in some embodiments, a customer information database may include information regarding a customer's credit history, payment history, order history, order status, delivery preferences, order preferences, etc.

As illustrated by the customer information database 300 of FIG. 6, the customer identified as “C-123456” in the field 302 is named “ACME COMPANY” and has a primary contact identified as “BILL JONES” who can be reached at “BILL@ACME.COM”. The customer identified as “C-123456” is associated with the order identified as “O-987654” in the field 308. In some embodiments, information regarding one or more orders may be found in, or ordered from, an order information database.

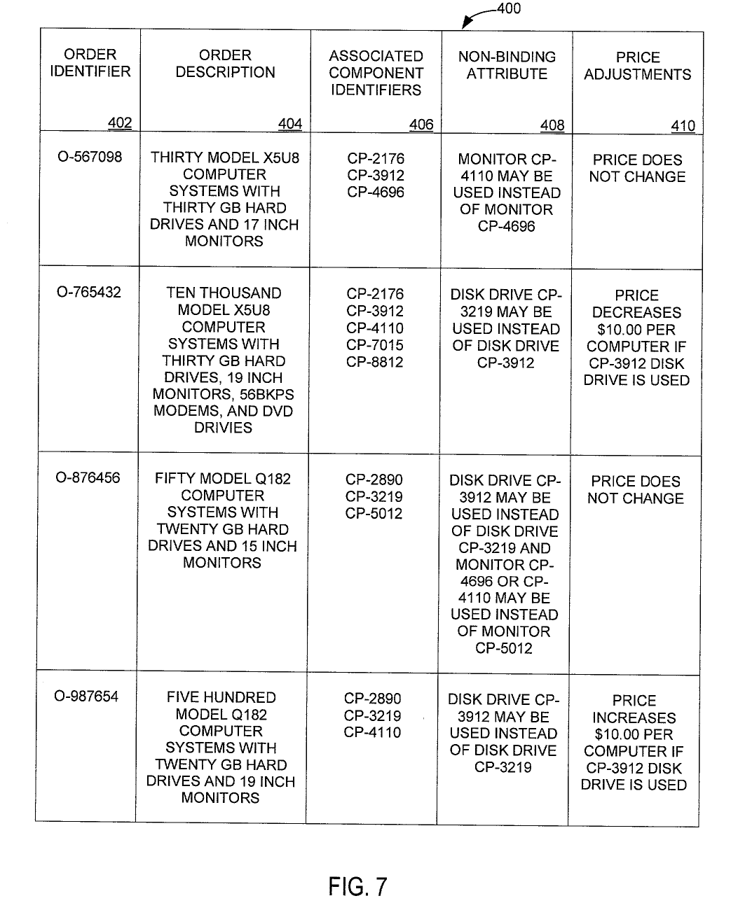

As previously discussed above, in some embodiments a server, user device, or other device may include or access an order information database for storing or keeping information regarding one or more orders. One representative order information database 400 is illustrated in FIG. 7.

The order information database 400 may include an order identifier field 402 that may include codes or other identifiers for one or more orders, an order description field 404 that may include descriptions or other information associated with the orders identified in the field 402, an associated component identifiers field 406 that may include codes or other identifiers for products, components, items, units, etc. associated with the orders identified in the field 402, a non-binding attribute description field 408 that may include information regarding one or more non-binding attributes associated with the orders identified in the field 402, and a price adjustment field 410 that may include information regarding one or more price adjustments that may apply to the orders identified in the field 402 if one or more non-binding attributes are used with the orders.

Other or different fields also may be used in the order information database 400. For example, in some embodiments an order information database may include information regarding customers associated with the orders identified in the field 402, wholesale or retail prices associated with the orders identified in the field 402 or the components identified in the field 406, information regarding suppliers or manufacturers associated with the components identified in the field 406, etc. A component may be associated with more than one order, and vice versa.

As illustrated by the order information database 400 of FIG. 7, the order identified as “O-567098” in the field 402 comprises “THIRTY MODEL X5U8 COMPUTER SYSTEMS WITH THIRTY GB HARD DRIVES AND 17 INCH MONITORS”. The order “O-567098” has three associated components identified as “CP-2176”, “CP-3912” and “CP-4696” in the field 406. In some embodiments, information regarding one or more components may be found in a component information database. The three components identified in the field 406 for the order “O-567098” may comprise a default or base configuration or component list for the order “O-567098”. As illustrated in the field 408 for the order “O-567098”, the monitor “CP-4110” may be used with the order “O-567098” instead of the monitor “CP-4696” with no change in price.

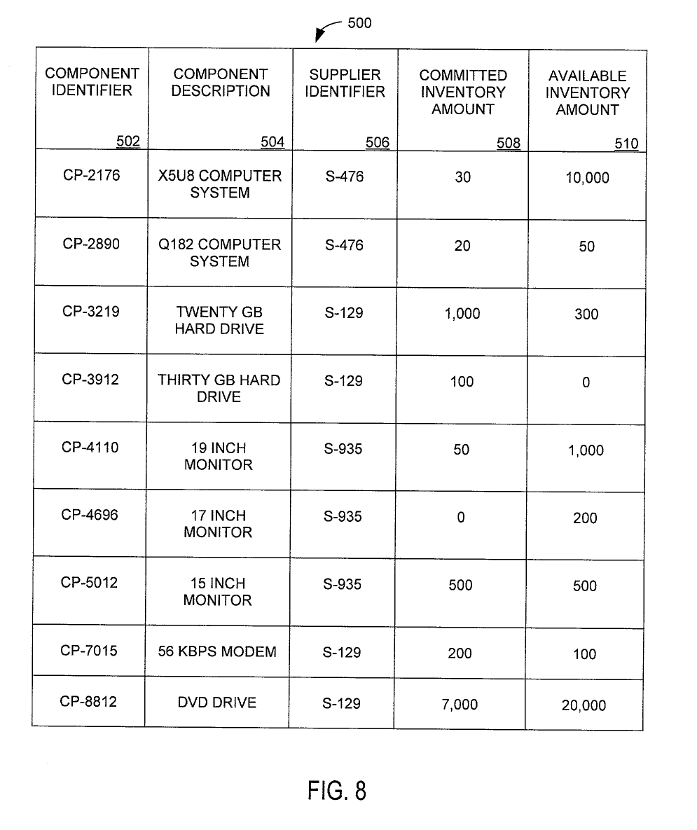

As previously discussed above, in some embodiments a server, user device, or other device may include or access a component information database for storing or keeping information regarding one or more components, products, etc. One representative component information database 500 is illustrated in FIG. 8.

The component information database 500 may include a component identifier field 502 that may include codes or other identifiers for one or more components, a component description field 504 that may include names, descriptions or other information regarding the components identified in the field 502, a supplier identifier field 506 that may include codes or other identifiers for suppliers of the components identified in the field 502, a committed inventory amount field 508 that may include information regarding the amount of components identified in the field 502 that have been committed to particular orders, and an available inventory amount field 510 that may include information regarding an amount of the components identified in the field 502 currently available in inventory. In some embodiments, a component may be available from more than one supplier and/or a supplier may be able to provide more than one component.

Other or different fields also may be used in the component information database 500. For example, in some embodiments a component information database may include operational, installation, maintenance, upgrade, performance, price, etc. information regarding the components identified in the field 502. It may also include information that can be used to determine supply levels not available in inventory, such as outstanding supplier order commitments, projections of component availability, alternative sources of supply, etc.

As illustrated by the component information database 500 of FIG. 8, the component identified as “CP-2890” in the field 502 is a “Q182 COMPUTER SYSTEM” as identified in the field 504, and is supplied by the supplier identified as “S-476” in the field 506. Fifty of the “CP-2890” components are available in inventory while twenty of the “CP-2890” components have been committed or are currently committed to orders. The component identified as “CP-3219” in the field 502 is a “TWENTY GB HARD DRIVE” supplied by the supplier identified as “S-129” in the field 506. Three hundred of the “CP-3219” components are available in inventory while one thousand of the “CP-3219” components have been committed or are currently committed to orders.

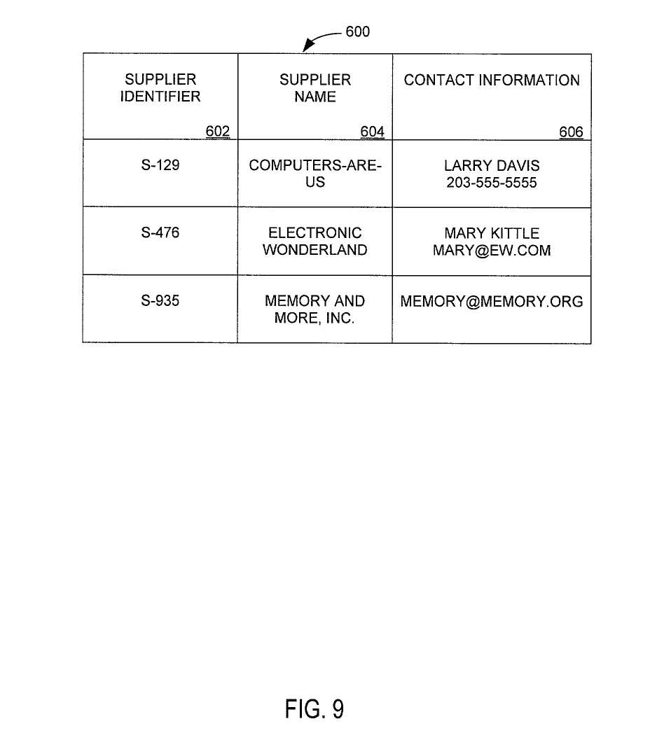

As previously discussed above, in some embodiments a server, user device, or other device may include or access a supplier information database for storing or keeping information regarding one or more suppliers. One representative supplier information database 600 is illustrated in FIG. 9.

The supplier information database 600 may include a supplier identifier field 602 that may include codes or other identifiers for one or more suppliers, a supplier name field 604 that may include names, descriptions or other information for the suppliers identified in the field 602, and a contact information field 606 that may include contact information for the suppliers identified in the field 602. Other or different fields also may be used in the supplier information database 600. For example, in some embodiments a supplier information database may include information regarding components manufactured, distributed, supplied, etc. by the suppliers identified in the field 602 In some embodiments, a supplier information database may also include information about committed orders or projected supply availability for suppliers identified in field 602. As illustrated by the supplier information database 600 of FIG. 9, the supplier identified as “S-129” in the field 602 is named “COMPUTERS-ARE-US” and has a primary contact identified as “LARRY DAVIS” who can be reached at “203-555-5555”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention, and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to different embodiments, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for developing an order for a product, comprising:
establishing an order for a product, wherein said order includes a first component associated with said product and said order includes a non-binding attribute associated with said first component;
determining a second component that satisfies said non-binding attribute for said order; and
exchanging said first component with said second component in said order.

2. The method of claim 1, wherein said order comprises a legal contract.

3. The method of claim 1, wherein said establishing an order for a product includes at least one of the following:
providing a notification to a customer regarding said non-binding attribute;
receiving an order for said product;
allowing a customer to select a plurality of components for said product, wherein said first component is one of said plurality of components;
allowing a customer to select said product and said non-binding attribute;
providing a notification to a customer regarding said first component and said second component and receiving consent from said customer to said non-binding attribute;
providing at least two options regarding at least one component for said product and allowing a customer to select from among said two options; and
providing a request to a customer regarding a non-binding attribute associated with said first component.

4. The method of claim 1, further comprising:
determining a need for said first component outside said order;

5. The method of claim 4, wherein said determining a need for said first component outside said order includes at least one of the following:
receiving a notification regarding a new order that requires said first component;
determining that said order cannot be completely fulfilled due to a shortage of said first component;
receiving a new order that requires an amount of said first component such that both said order and said new order cannot be filled if both said order and said new order use said first component;
determining that said order cannot be partially or completely filled due to defects detected in said first component;
determining that a change in price for said first component makes it disadvantageous to fill said order with said first component;
determining that a change in price for a second component makes it disadvantageous to fill said order with said first component;
determining that a change in projected supply for said first component makes it disadvantageous to fill said order with said first component;
determining that a change in projected supply for a second component makes it disadvantageous to fill said order with said first component;
determining that a projected change in price for said first component makes it disadvantageous to fill said order with said first component;
determining that a projected change in price for a second component makes it disadvantageous to fill said order with said first component;
establishing a new order that requires said first component; and
receiving an indication of a potential new order that requires said first component.

6. The method of claim 1, wherein said determining a second component that satisfies said non-binding attribute for said order includes at least one of the following:
identifying a component that can replace said first component in said product and satisfy said non-binding attribute;
selecting said second component from a plurality of components identified in said order as replacements for said first component;
receiving a notification of a selection of said second component;
providing a notification of availability of said second component;
receiving a request to exchange said first component with said second component;
receiving consent to exchange said first component with said second component;
providing a notification to a customer of at least one component that satisfies said non-binding attribute;
confirming availability of said second component; and
confirming ability of said second component to satisfy said non-binding attribute.

7. The method of claim 1, wherein said exchanging said first component with said second component in said order includes at least one of the following:
using said second component but not said first component when building said product;
fulfilling said order using said second component but not said first component;
using said second component but not said first component when providing said product; and
including said second component in said product.

8. The method of claim 1, wherein said non-binding attribute relates to at least one of the following:
a quality level of said first component;
a performance level of said first component;
a feature set of said first component;
a delivery date for said first component;
a color of said first component;
a size of said first component;
a storage capacity of said first component;
a bandwidth of said first component;
a weight of said first component;
a technical capability of said first component;
an expiration date;
a purity level;
a service level;
a warranty level;
a price; and
a dimension associated with said first component.

9. The method of claim 1, further comprising:
providing a notification regarding said exchanging said first component with said second component.

10. The method of claim 1, further comprising:
fulfilling said order using said second component.

11. The method of claim 1, further comprising:
adjusting a price associated with said order as a result of said exchanging said first component with said second component.

12. The method of claim 11, further comprising:
providing a notification regarding said price.

13. The method of claim 1, further comprising:
establishing a second order using said first component.

14. The method of claim 13, wherein said order is established with a first customer and said second order is established with a second customer.

15. The method of claim 1, wherein said order identifies at least one characteristic associated with said product.

16. The method of claim 15, further comprising:
receiving identification of said at least one characteristic regarding said order.

17. The method of claim 15, further comprising:
determining said second component based, at least in part, on said characteristic.

18. The method of claim 15, further comprising:
determining said non-binding attribute based, at least in part, on said characteristic.

19. The method of claim 15, wherein said determining a second component that satisfies said non-binding attribute for said order includes selecting said second component based, at last in part, on said characteristic.

20. The method of claim 15, wherein said at least one characteristic includes at least one of the following:
an acceptable lower bound of said at least one characteristic;
an acceptable upper bound of said at least one characteristic;
a range of acceptable characteristics;
a range of unacceptable characteristics;
a rule regarding exchange of said first component with said second component;
a condition that must be met if said first component is exchanged with said second component;
a set of at least one acceptable characteristic for said product;
a set of at least one acceptable characteristic for said first component;
a set of at least one acceptable characteristic for said second component;
a set of at least one unacceptable characteristic for said product;
a set of at least one unacceptable characteristic for said first component; and
a set of at least one unacceptable characteristic for said second component.

21. The method of claim 15, further comprising:
identifying said at least one characteristic.

22. The method of claim 15, wherein said at least one characteristic is based on at least one of the following:
volume of said product included in said order;
quantity of said product included in said order;
quality of said product;
quality of said first component;
quality of said second component;
demand for said product;
demand for said first component;
demand for said second component;
supply for said product;
supply for said first component;
supply for said second component;
availability of said first component;
availability of said second component;
an amount in inventory of said product;
an amount in inventory of said first component;
an amount in inventory of said second component;
an expected profit margin for said product wherein said product includes said first component;
an expected profit margin for said product wherein said product includes said second component;
a discount available for said product;
a price of said product;
a price of said first component;
a price of said second component
projected demand for said product;
projected demand for said first component;
projected demand for said second component;
projected supply for said product;
projected supply for said first component;
projected supply for said second component;
projected availability of said first component;
projected availability of said second component;
projected amount in inventory of said product;
projected amount in inventory of said first component;
projected amount in inventory of said second component;
a projected price of said product;
a projected price of said first component; and
a projected price of said second component.

23. The method of claim 15, wherein said characteristic is identified by at least one of the following:
a party placing said order;
a supplier of said product;
a supplier of said first component;
a supplier of said second component;
an expert system;
a rule-based system;
a supply chain management decision support system;
a supplier relationship management decision support system;
a production control decision support system;
a forecasting system;
an optimization system;
an order model; and
a customer model.

24. The method of claim 1, wherein said order specifies different prices for different configurations of said product.

25. The method of claim 1, further comprising:
determining said non-binding attribute.

26. The method of claim 1, further comprising:
providing said product.

27. A method for fulfilling an order for a product, comprising:
establishing an order, wherein said order identifies an initial configuration for a product and at least one non-binding attribute associated with said initial configuration;
after said order is established, determining an alternate configuration for said product in accordance with said at least one non-binding attribute; and
fulfilling said order in accordance with said alternate configuration.

28. The method of claim 27, wherein said establishing an order includes at least one of the following:
providing a notification to a customer regarding said non-binding attribute;
receiving an order for said product from a customer;
receiving a request from a customer for said product in said initial configuration;
allowing a customer to select a plurality of components for said product;
allowing a customer to select said product and said non-binding attribute;
allowing a customer to select said product and said initial configuration;
providing a notification to a customer regarding said initial configuration and receiving consent from said customer to said non-binding attribute;
providing at least two options regarding said initial configuration for said product and allowing a customer to select from among said at least two options;
providing at least two options regarding at least one component for said product and allowing a customer to select from among said at least two options;
providing at least two options regarding said non-binding attribute and allowing a customer to select from among said at least two options; and
providing a request to a customer regarding said non-binding attribute.

29. The method of claim 27, wherein said determining an alternate configuration for said product in accordance with said at least one non-binding attribute includes at least one of the following:
selecting an alternate configuration permitted in said order;
determining a component that can replace another component in the product and satisfy the non-binding attribute;
determining a component that can replace another component in said product and satisfy said non-binding attribute;
receiving a notification of a selection of an alternative component for said product;
receiving consent to exchange said initial configuration with said alternate configuration;
providing a notification of availability of said alternate configuration;
receiving a request to exchange said initial configuration with said alternate configuration;
providing a notification to a customer of at least one component that satisfies said non-binding attribute and is usable in said alternate configuration;
providing a notification to a customer of at least one component that is unavailable for use in said initial configuration;
providing a notification to a customer of at least one component that is available for use in said alternate configuration; and
confirming ability of a component to satisfy said non-binding attribute.

30. The method of claim 27, wherein said fulfilling said order in accordance with said alternate configuration includes at least one of the following:
providing a notification that said order is provided in accordance with said alternate configuration;
providing a notification that said product is provided in accordance with said alternate configuration;
building said product in accordance with said alternate configuration but not said initial configuration;
providing said product in accordance with said alternate configuration but not said initial configuration;
providing said order in accordance with said alternate configuration but not said initial configuration; and
using a component with said product that is included in said alternate configuration but not said initial configuration.

31. The method of claim 27, wherein said order comprises a legal contract

32. The method of claim 27, further comprising:
determining said non-binding attribute.

33. The method of claim 27, further comprising:
adjusting a price associated with said order as a result of said exchanging said initial configuration with said alternate configuration.

34. The method of claim 27, wherein said order specifies different prices for different configurations of said product.

35. A method for completing an order for a product, comprising:
establishing an order involving a first component, wherein said order includes a non-binding attribute associated with said first component;
determining a shortage of an amount of said first component needed to for said order;
determining a second component that satisfies said non-binding attribute for said order; and
exchanging said first component with said second component for said order.

36. The method of claim 35, wherein said establishing an order involving a first component includes at least one of the following:
providing a notification to a customer regarding said non-binding attribute;
receiving an order for a product that includes said first component;
allowing a customer to select a plurality of components for said product, wherein said first component is one of said plurality of components;
allowing a customer to select said non-binding attribute;
providing a notification to a customer regarding said first component and said second component and receiving consent from said customer to said non-binding attribute;
providing a notification to a customer regarding a component and receiving consent from the customer to use said component in said order;
providing a notification to a customer regarding a non-binding attribute and receiving consent from said customer to use the non-binding attribute in the order;
providing at least two options regarding a component and allowing a customer to select from among the two options; and
providing a request to a customer regarding a non-binding attribute associated with said first component.

37. The method of claim 35, wherein said determining a shortage of an amount of said first component needed for said order includes at least one of the following:
receiving a second order involving said first component, fulfillment of which prevents fulfillment of said order with said first component;
determining availability of an amount of said first component needed to fulfill said order;
determining that said order cannot be partially or completely filled due to defects detected in said first component;
determining that a change in price for said first component makes it disadvantageous to fill said order with said first component;
determining that a change in price for a second component makes it disadvantageous to fill said order with said first component;
determining that a change in projected supply for said first component makes it disadvantageous to fill said order with said first component;
determining that a change in projected supply for a second component makes it disadvantageous to fill said order with said first component;
determining that a projected change in price for said first component makes it disadvantageous to fill said order with said first component;
determining that a projected change in price for a second component makes it disadvantageous to fill said order with said first component;
determining that an amount of said first component needed for said order exceeds an amount of said first component that is available for said order; and
determining that an amount of said first component needed for said order exceeds an amount of said first component in inventory.

38. The method of claim 35, wherein said order comprises a legal contract.

39. The method of claim 35, further comprising:
determining said non-binding attribute.

40. The method of claim 35, further comprising:
adjusting a price associated with said order as a result of said exchanging said first component with said second component.

41. The method of claim 35, wherein said order specifies different prices for different configurations of a product associated with said order.

42. A system for facilitating an order for at least one product, comprising:
a memory;
a communication port; and
a processor connected to said memory and said communication port, said processor being operative to:
establish an order for a product, wherein said order includes a first component associated with said product and said order includes a nonbinding attribute associated with said first component;
determine a second component that satisfies said non-binding attribute for said order; and
exchange said first component with said second component in said order.

43. A computer program product in a computer readable medium for facilitating an order for at least one product, comprising:
first instructions for creating an order for a product, wherein said order includes a first component associated with said product and said order includes a non-binding attribute associated with said first component;
second instructions for identifying a second component that satisfies said non-binding attribute for said order; and
third instructions for allowing use of said first component with said second component in said order.
